(19) United States
(12) Patent Application Publication
(10) Pub. No.: US 2007/0077149 A1
(43) Pub. Date: Apr. 5, 2007

(54) Compressor blade with a chamfered tip

(75) Inventors: Claude Robert Louis Lejars, Draveil (FR); Nicolas Christian Triconnet, Saint Fargeau Ponthierry (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/524,896

(22) Filed: Sep. 22, 2006

(30) Foreign Application Priority Data
Sep. 30, 2005 (FR) 0510010

(51) Int. Cl. B64C 27/46

(52) U.S. Cl. 416/223 R

(57) ABSTRACT

The invention relates to a compressor blade for a rotary disk of a turbine engine, the blade presenting orthogonal axes that are longitudinal, tangential, and radial, said blade extending radially between a root and a tip, and longitudinally between a leading edge and a trailing edge, said blade being for rotating inside an outer stator shroud having its surface covered in an abradable material. In the invention the tip of the blade presents at least one chamfer in order to reduce the area of contact that can exist between the tip of the blade and the abradable material.

The present invention relates to the field of gas turbine engines, and in particular to the compressors of such engines.

More particularly, the invention relates to a compressor blade for such an engine, the blade having longitudinal, tangential, and radial axes, said blade extending radially between a root and a tip, and longitudinally between a leading edge and a trailing edge, said blade being designed to rotate inside an outer stator shroud having its surface covered in an abradable material.

### BACKGROUND OF THE INVENTION

A gas turbine engine traditionally comprises a combustion section and a turbine section located downstream from a compression section. An annular passage followed by a flow of gas extends axially through these various sections of the engine. The gas flow is compressed by the compression section prior to being mixed with fuel and burnt in the combustion section. The gas resulting from the combustion then passes through the turbine section so as to provide propulsion thrust and drive the turbines that are connected in turn via respective drive shafts to the rotary elements of the compression section.

The compression section of a gas turbine engine may comprise a plurality of compressors disposed in succession along the axial direction of the engine in order to increase the compression of the gas flow.

For example, with a twin-spool engine, on going axially from the upstream portion of the engine, the compression section comprises in succession: a fan; a low-pressure compressor; and a high-pressure compressor. Each of the compressors comprises a rotary portion (the rotor) and a stationary portion (the stator) together with a shell (the casing). An inner rotor shroud and an outer stator shroud define the radial extent of the annular passage for gas flow through the compressor.

The stator comprises a plurality of rows of stator vanes secured to the outer stator shroud and also extending across the flow passage as far as the inner rotor shroud.

The rotor of a compressor comprises a plurality of rows of compressor blades extending radially through the flow passage from the inner rotor shroud to the vicinity of the outer stator shroud.

In order to improve the efficiency of the compressor, it is advantageous to minimize the clearance that exists between the tips of the compressor blades and the outer stator shroud. One technique, that does not relate to the present invention, consists in covering the outer stator shroud in a layer of abrasive material, which is suitable for abrading the blade tips whenever they come into contact with said material.

Another technique, to which the present invention does apply, consists in covering the outer stator shroud in a layer of abradable material, i.e. material that is suitable for being abraded by the blade tips if they come into contact with said material, as can occur in particular because of vibration propagating through the engine.

The Applicant has found that when the blade tips come into contact with the abradable material, the blade tips are subjected to mechanical forces because of the contact they make with said material.

These mechanical forces constitute a source of vibration that propagates through the blades. Above certain levels of amplitude and/or frequency, such vibration can cause a blade to resonate in one of its resonant modes, thereby fatiguing the blade and possibly causing it to break.

The Applicant has also observed that longitudinal cracks can appear in a critical zone situated in particular close to the root of the blade, and the blade is then in danger of breaking at this location.

### OBJECT AND SUMMARY OF THE INVENTION

The invention seeks to provide, for a compressor in which the outer stator shroud is covered in an abradable material, a compressor blade having provision against the appearance of such cracks and therefore against the blade breaking.

The invention achieves its object by the fact that the blade tip presents at least one chamfer for the purpose of reducing the area of contact that can exist between the blade tip and the abradable material.

In previously known compressor blades, the surface of the blade tip is shaped in such a manner that in operation, when the blade is untwisted, said surface extends in a plane that is substantially tangential to the outer stator shroud.

Consequently, the area of contact that can exist between the blade tip and the abradable material corresponds substantially to the area of the surface at the tip of the blade.

In contrast, in operation of the engine of the invention, the portion of the blade that is chamfered in accordance with the present invention does not lie in a plane that is substantially tangential to the outer stator shroud.

As a result, it will be understood that when the engine is in operation, the area of contact that can exist between the tip of a blade of the present invention and the abradable material is smaller than that which can exist with prior art blades.

This reduction in contact area serves to reduce the radial and tangential forces to which the tip of the blade is subjected in the event of coming into contact with the layer of abradable material, and consequently serves to minimize vibration in the blade.

Preferably, said at least one chamfer extends over substantially the entire length of the blade, where blade length is naturally taken in the longitudinal direction of the blade.

Furthermore, the leading and trailing edges at the tip of the blade constitute the ends of a chord and, when seen in a plane orthogonal to the chord, the chamfer advantageously comprises a portion that is inclined relative to a plane that is tangential to the tip of the blade.

In known manner, the blade has suction-side and pressure-side surfaces extending radially between its root and its tip, and longitudinally between the leading edge and the trailing edge, in such a manner that the radial height of the pressure-side surface is advantageously slightly greater than the radial height of the suction-side surface.

It can thus be understood that said at least one chamfer is disposed on the suction side.

In a preferred embodiment, the blade tip has a single chamfer and the angle of inclination of the chamfer is substantially the same over the entire length of the chord.

The angle of inclination preferably opens out towards the suction side of the blade.

Advantageously, the angle of inclination lies in the range 5° to 20°.

Also advantageously, the residual area at the tip of the blade presents a width lying in the range 0.1 millimeters (mm) to 0.9 mm.

Preferably, this residual area extends in a plane that is tangential to the outer stator shroud when the engine is in operation.

Other characteristics and advantages of the invention appear better on reading the following description of an embodiment of the invention given by way of non-limiting example.

### BRIEF DESCRIPTION OF THE DRAWINGS

The description refers to the accompanying figures, in which:

FIG. 1 is a fragmentary view in longitudinal section of a compression section of a gas turbine engine;

FIG. 2 shows a compressor blade of the present invention when its tip is in contact with an abradable layer of an outer stator shroud;

FIG. 3 is a plan view of a compressor blade of the present invention; and

FIG. 4 is a fragmentary section view in a plane orthogonal to the chord at the tip of a blade of the present invention.

### MORE DETAILED DESCRIPTION

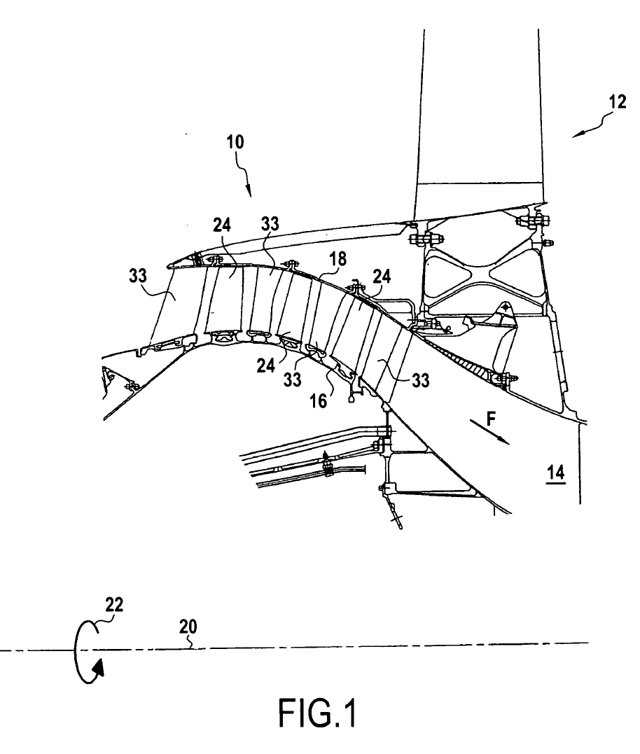

FIG. 1 shows part of a compression section 10 of a gas turbine engine 12. The compression section presents an annular passage 14 for conveying gas flow that extends longitudinally through the engine and radially between an inner shroud 16 of a rotor disk and an outer shroud 18 of a stator. The inner shroud is suitable for being set into rotation about a longitudinal axis 20 of the engine in the direction indicated by arrow 22, while the outer shroud of the stator remains stationary. The direction of the gas flow through the passage is represented in the figures by arrow F.

The rotor disk carries a plurality of rows 24 of compressor blades extending radially between the inner shroud 16 of the rotor disk and the outer shroud 18 of the stator. Each of the compressor blades 24 presents a root 28 which is engaged in a recess in the rotor disk, a bottom airfoil portion 26 of the blade, and a tip 30 remote from the root 28.

The stator comprises a plurality of stator vanes 33 secured to the outer shroud 18 of the stator and likewise extending through the gas flow passage between the outer shroud 18 of the stator and the inner shroud 16 of the rotor. As can be seen in FIG. 1, the rows of compressor blades 24 and of stator blades 34 are disposed in alternation along the axial direction 20 of the engine 12.

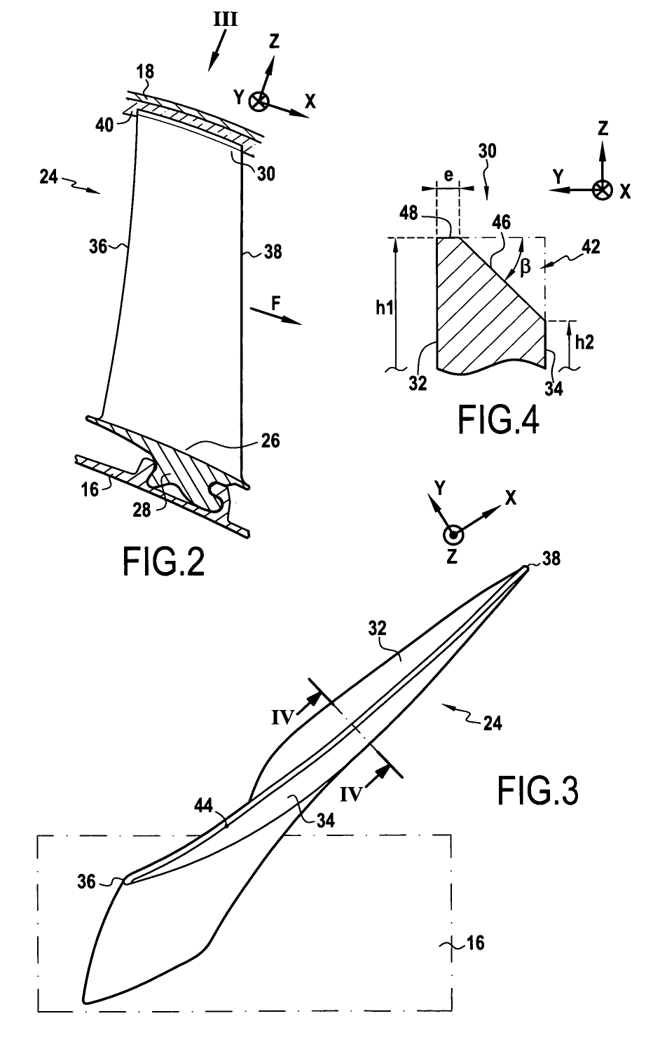

FIG. 2 shows a compressor blade 24 of the invention that belongs preferably, but not necessarily, to the row of compressor blades that is situated at the downstream end of the compressor section.

The compressor blade 24 of the invention is provided with an orthogonal frame of reference comprising a longitudinal axis X, a tangential axis Y, and a radial axis Z. The longitudinal axis X extends in the flow direction F, the tangential axis Y extends in the direction of rotation of the inner, rotor shroud 16, while the radial axis Z extends radially from the inner shroud 16 towards the outer shroud 18.

Each compressor blade 24 has a pressure-side surface 32 and a suction-side surface 34 extending radially between the bottom airfoil portion 26 and the tip 30 of the compressor blade 24, and longitudinally between a leading edge 36 and a trailing edge 38.

As can be seen in FIG. 2, the inside surface of the outer stator shroud 18 is covered in a layer of abradable material 40, i.e. material that is suitable for being abraded by the tip of a compressor blade if it comes into contact with the material. This contact can occur because of vibration in the engine, given the small clearance that exists between the tip of the compressor blade 24 and the layer of material covering the outer stator shroud 18.

In order to minimize the forces to which the compressor blade is subjected on coming into contact with the layer of abradable material 40, the tip of the blade presents a chamfer 42, as shown in FIG. 4.

The chamfer 42 preferably extends over the entire length of the chord 44 of the tip 30 of the blade 24, i.e. extending substantially between the leading edge 36 and the trailing edge 38.

The chamfer 42 preferably presents a plane surface 46 that is inclined at an angle β relative to a plane tangential to the tip of the blade. Nevertheless, the chamfer could present a surface that is curved, being concave or convex, without thereby going beyond the ambit of the present invention.

As a result, the radial height hi of the pressure-side face 32 is slightly greater than the radial height h2 of the suction-side face 34.

According to an advantageous characteristic of the invention, the angle of inclination β lies in the range 5° to 20°. In this range of value, a clear reduction has been observed in the amplitudes of the tangential and radial forces applied to the tip of the blade.

In an advantageous variant, the chamfered edge 42 does not extend quite as far as the pressure-side face 32 such that the tip of the blade presents a residual surface 48 of width in the tangential direction that is referenced e in FIG. 4.

Advantageously, this residual surface 48 extends in a plane that is tangential to the outer, stator shroud 18 when the engine is in operation, and it presents a width lying in the range 0.1 mm to 0.9 mm.

The shape of the tip of the compressor blade 24 of the present invention serves to reduce the area that can come into contact with the layer of abradable material, and consequently serves to reduce the mechanical forces to which the blade is subjected on coming into contact with the layer 40 of abradable material. This reduction in forces limits the appearance of vibration that might cause the blade to resonate and could consequently lead to the blade breaking.

Although the description above relates to compressor blades of a twin-spool turbomachine, the present invention also applies to a single-spool turbomachine (no fan), or to a triple-spool turbomachine in which an intermediate compressor is disposed between the low-pressure compressor and the high-pressure compressor.

The present invention also relates to a compressor rotor having at least one row of blades in accordance with the present invention, and to a turbomachine including such a compressor rotor.

What is claimed is:

1. A compressor blade for a rotary disk of a turbine engine, the blade presenting orthogonal axes that are longitudinal, tangential, and radial, said blade extending radially between a root and a tip, and longitudinally between a leading edge and a trailing edge, said blade being for rotating inside an outer stator shroud having its surface covered in an abradable material, the tip of the blade presenting at least one chamfer in order to reduce the area of contact that can exist between the tip of the blade and the abradable material, wherein, when seen in a tangential direction, the residual contact surface of the blade tip presents a width lying in the range 0.1 mm to 0.9 mm.

2. A compressor blade according to claim 1, wherein said at least one chamfer extends over substantially the entire length of the blade.

3. A compressor blade according to claim 1, wherein the leading and trailing edges at the tip of the blade constitute the ends of a chord, and wherein, when seen in a plane orthogonal to the chord, the chamfer comprises a portion that is inclined relative to a plane tangential to the tip of the blade.

4. A compressor blade according to claim 1, wherein the blade has suction-side and pressure-side surfaces extending radially between the root and the tip and longitudinally between the leading edge and the trailing edge, and wherein the radial height of the pressure side is slightly greater than the radial height of the suction side.

5. A compressor blade according to claim 1, wherein the leading and trailing edges at the tip of the blade constitute the ends of a chord, wherein the blade has a single chamfer, and wherein the angle of inclination of the chamfer is substantially the same over the entire length of the chord.

6. A compressor blade according to claim 5, wherein the angle of inclination lies in the range 5° to 20°.

7. A compressor rotor, including at least one row of blades according to claim 1.

8. A turbomachine, including a rotor according to claim 7.
